(19) United States
(12) Patent Application Publication
(10) Pub. No.: US 2021/0211317 A1
(43) Pub. Date: Jul. 8, 2021

(54) CONTROLLING CONFERENCE CALL DIAL-INS AND HOLDING QUEUES

(71) Applicant: International Business Machines Corporation, Armonk, NY (US)

(72) Inventors: Naweed A. Khan, Johannesburg (ZA); Komminist Weldemariam, Ottawa (CA); Solomon Assefa, Ossining, NY (US)

(21) Appl. No.: 16/733,532

(22) Filed: Jan. 3, 2020

(51) Int. Cl. H04L 12/18; G06Q 10/10; G06F 21/62; H04N 7/15

(52) U.S. Cl. CPC H04L 12/1822; H04N 7/155; G06F 21/62; G06Q 10/109

(57) ABSTRACT

A method of operating a computer system configured to managing a digital conference call including a virtual holding queue includes establishing, by the computer system, the digital conference call connecting a plurality of current attendees, determining and classifying in real-time a confidentiality status of data being exchanged by the current attendees through the digital conference call, profiling each of the current attendees, profiling at least one caller attempting to join the digital conference call, modifying at least one content restriction on the data being exchanged in response to the profiling of the current attendees and the at least one caller, and enforcing, by the computer system, an eligibility criteria for the at least one caller to join the digital conference call based on the confidentiality status of the data.

### BACKGROUND

Secure digital discussion forums, e.g., in the form of a video streaming conference call, are often needed to confer intellectual material. Often, this material is confidential in nature even if not explicitly specified in the call detail. The construction of such a digital discussion forum, including the curation of a list of desired (e.g., trusted) call members, setting up a calendar event, emailing listed individuals, hosting a secure discussion area, etc., is typically undertaken by the conference call host with the support of existing enterprise conference call software containing appropriately authentication services.

### BRIEF SUMMARY

According to one or more embodiments of the present invention, conference calls are managed (e.g., for sensitive or confidential material). These conference calls can include functionality for sharing digital video feeds, voice, presentation content, etc. According to some embodiments, the management of the conference calls is facilitated by holding queues, where discussions can be virtually hosted. According to at least one embodiment, the holding queues include functionality for identification and classification of potentially confidential information, contextual user profiling, and content restrictions management that allows trusted call hosts and administrators to modify content visibility and call interactivity available to call members based on an analysis of their profiles.

According to some embodiments of the present invention, a method of operating a computer system configured to managing a digital conference call including a virtual holding queue includes establishing, by the computer system, the digital conference call connecting a plurality of current attendees, determining and classifying in real-time a confidentiality status of data being exchanged by the current attendees through the digital conference call, profiling each of the current attendees, profiling at least one caller attempting to join the digital conference call, modifying at least one content restriction on the data being exchanged in response to the profiling of the current attendees and the at least one caller, and enforcing, by the computer system, an eligibility criteria for the at least one caller to join the digital conference call based on the confidentiality status of the data.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments provide one or more of:

managing a digital conference call including a virtual holding queue; and

dynamic restrictions on classes of call participants.

These and other features and advantages of the present invention will become apparent from the following detailed description of illustrative embodiments thereof, which is to be read in connection with the accompanying drawings.

### BRIEF DESCRIPTION OF THE SEVERAL VIEWS OF THE DRAWINGS

Preferred embodiments of the present invention will be described below in more detail, with reference to the accompanying drawings:

FIG. 1 depicts a cloud computing environment according to an embodiment of the present invention;

FIG. 2 depicts abstraction model layers according to an embodiment of the present invention;

FIG. 3 depicts a user interface of a system configured to manage a conference call according to some embodiments of the present invention;

FIG. 4 depicts a user interface tool for a host calendar according to some embodiments of the present invention;

FIG. 5 is a diagram of a system configured to manage a conference call according to an exemplary embodiment of the present invention;

FIG. 6 is an illustration of a user interface for a virtual queue according to an exemplary embodiment of the present invention;

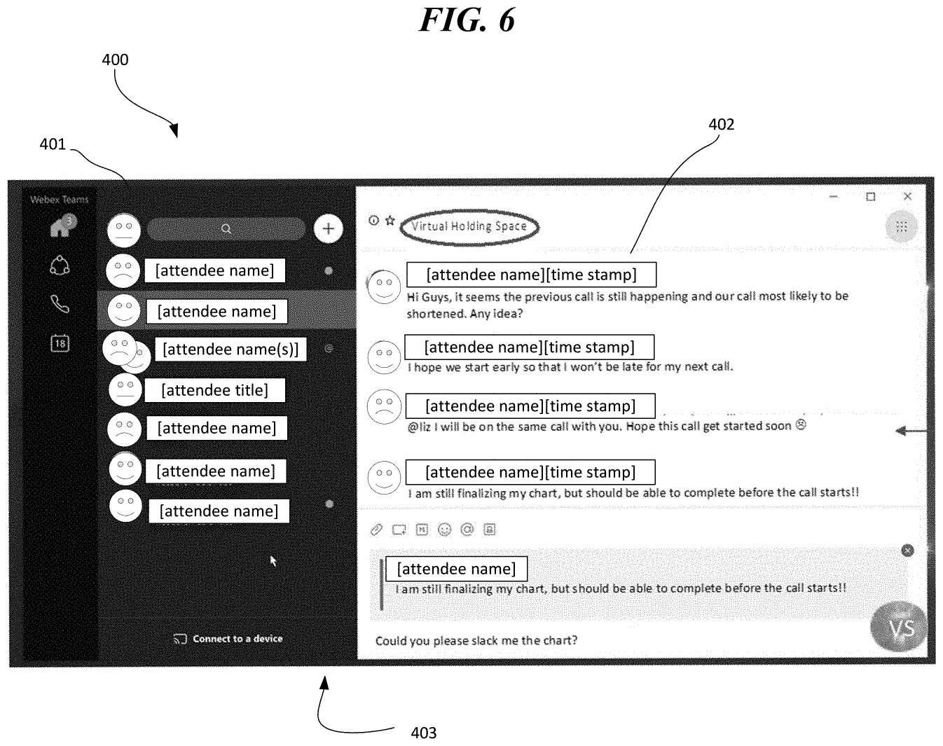

FIG. 7 is an illustration of a user interface for a virtual queue according to an exemplary embodiment of the present invention;

FIG. 8 is a flow diagram of a method of operating a computer system configured to manage a digital conference call including a virtual holding queue according to an exemplary embodiment of the present invention; and

FIG. 9 is a block diagram depicting an exemplary computer system embodying a method of managing a conference call according to an exemplary embodiment of the present invention.

### DETAILED DESCRIPTION

According to an embodiment of the present disclosure, digital conference calls may host a desired (e.g., trusted) subset of call members that are privileged to all the material, which may be confidential in nature, being conferred around a general topic of discussion, and more specifically to the conference call itself. These call members are determined to have the correct level of access to all related information. A second subset of call members (e.g., temporarily trusted) may be privileged only to the confidential material being conferred during a single call or portion thereof. An example thereof may be members that are not privileged to participate in the discussion (i.e., listen-only members), or members that may only listen to a given portion of the call and not all portions for which the first group is privileged to participate in. A third subset of call members may have access to a hosted conference call, but may be determined to be untrusted by the host or other trusted call members, bounded by the duration of the call (e.g., when scheduled callers log into a hosted call before their session begins, when scheduled callers log into a hosted call despite the previous session running over time, when random callers mistakenly log into a session at an incorrect time or for an incorrect host, etc.). The third subset of call members may represent a risk to a hosted call, e.g., to any confidential discussions taking place within a call session.

According to at least one embodiment of the present disclosure, confidentially controls are provided to a call host and/or a trusted administrator of a call session. These controls improve on conventional tools by allowing the host to facilitate confidential sessions, while maintaining degrees of communication and interactivity between the call host and semi-trusted participants, and potentially untrusted participants (e.g., that have attempted to join the call).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

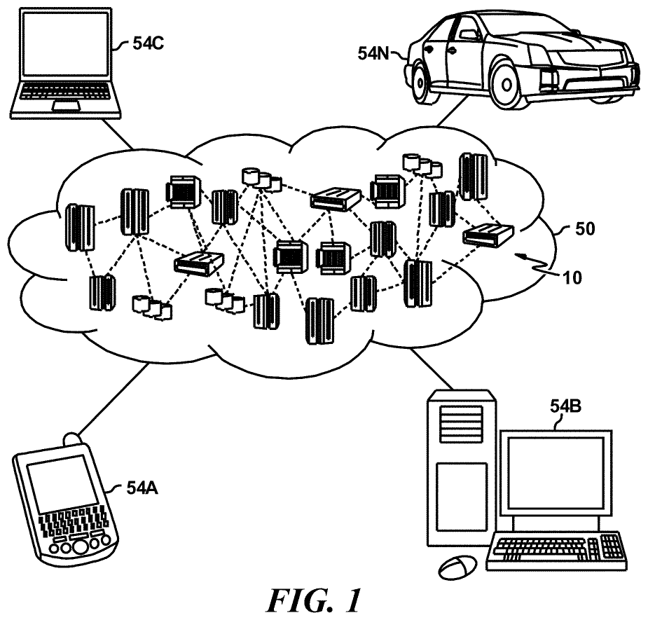

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

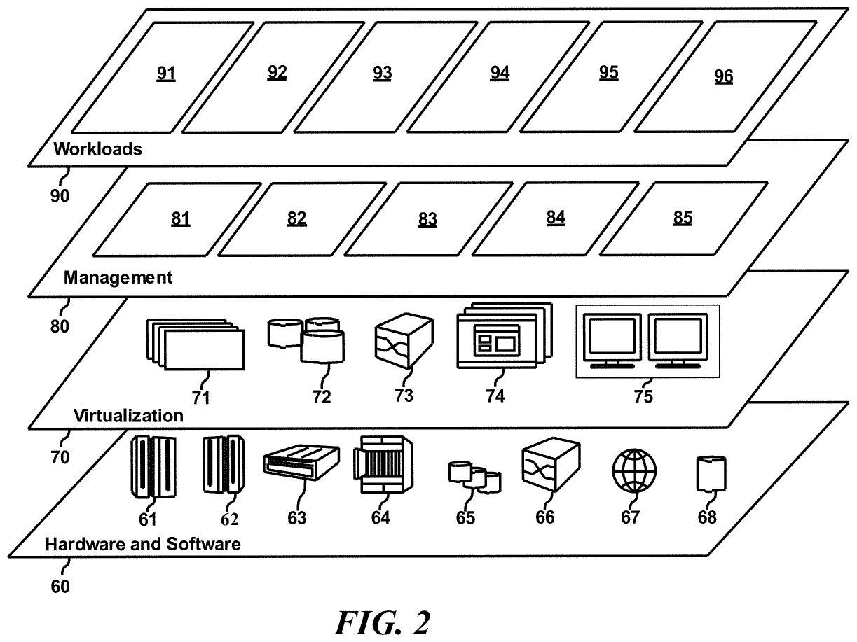

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and managing a digital conference call including a virtual holding queue 96 according to some embodiments of the present invention.

In the context of a digital conference call, embodiments of the present invention identify and/or classify the confidential nature of a current call, contextually screen profiles of individuals on the call or within a digital holding queue for the call, and employ control mechanisms that place confidentiality restrictions depending on an analysis of the profiles and a degree of access that a call administrator has set (i.e., via a tool) to enforce.

According to one or more embodiments of the present invention, conference calls are managed (e.g., for sensitive or confidential material). These conference calls can include functionality for sharing digital video feeds, voice, presentation content, etc. According to some embodiments, the management of the conference call is facilitated by one or more holding queues, where discussions can be virtually hosted. According to at least one embodiment, the holding queues include functionality for identification and classification of potentially confidential information, contextual user profiling, and content restrictions management that allows the trusted call host and/or administrators to modify content visibility and call interactivity available to call members based on an analysis of call member profiles.

According to some embodiments, the management of confidential discussions forums and (potentially) large conference (e.g., over 15 participants) call groups is a sensitive and time consuming process for the call host, where the call is required to be secure and accessible only to authorised and trusted call members.

According to embodiments of the present invention, methods and systems for managing confidential conference calls (e.g., sharing video feeds, voice, content, etc.) and holding queues where intellectual discussions can be virtually hosted, comprise confidentiality identification and classification, contextual user profiling, and content restrictions management that allows trusted a call host, an administrator or a dynamically identified trusted participant(s) to modify content visibility and call interactivity available to call members based on an analysis of their profiles.

In some embodiments, a conference call is an electronic (e.g., digital) framework, provided by a system, which supports discussion, conversation, presentation, shared desktop content, text chat, and/or combined conference viewing, and to which multiple users connect, offering an interactive and collaborative environment for engagement across a digital medium.

In some embodiments, a queue or holding queue is a virtual queueing or waiting framework that prevents users therein from entering a conference call without prior approval from the call host, administrator, and/or a real-time identified approver.

In some embodiments, the host is an owner of a conference call, with access to controls on the conference call, including all members in the call and/or holding queue.

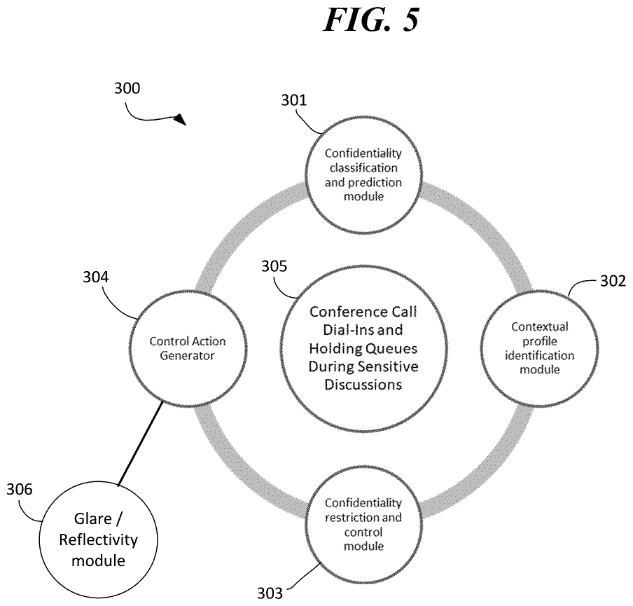

In some embodiments, the administrator or moderator is an individual or party of individuals that are identified (e.g., in an invitation list accessible to the computer system) as trusted by the conference call host, owner, or those who are automatically identified by the system (e.g., supervisors of invited attendees, close support staff of the invited attendees, etc.) (e.g., see FIG. 5), providing trusted parties confidentiality restriction controls over other individuals or parties who are in the call or holding in the queue.

In some embodiments, confidentiality restrictions are the set of restrictions or limits available to prevent a user or member in the call from accessing features available within a call or holding queue, controllable by the call owner (e.g., host or administrator). These restrictions can be compounded or grouped according to pre-set restriction profiles (e.g., the video feed not sharing any presentation content) or learned restriction over time.

In some embodiments, the term “trusted” refers to individuals with appropriate job roles for the call topic, discussion or content being shared and/or transmitted, individuals with topic expertise, a position in the organization, etc

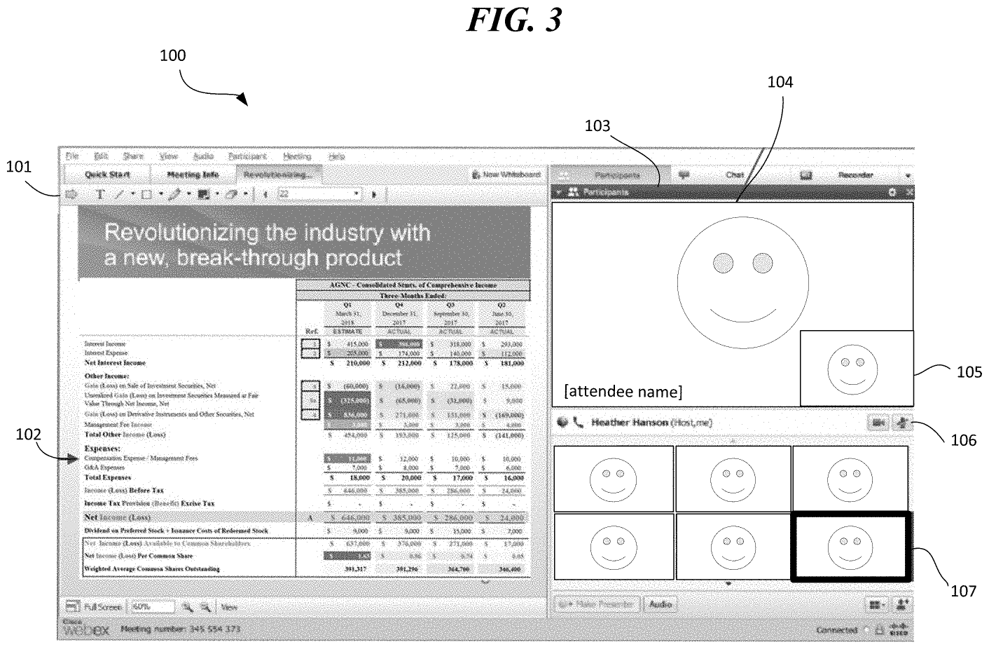

According to one or more embodiments, and as illustrated in FIG. 3, a user who is a host hosts a digital conference call (e.g., on a conference call service framework) with participants from different groups (for example, different divisions including finance controller, business development team, senior management team members) with the purpose of reviewing a certain topic, for example, the financial status of the host's own division. Through real-time analysis of a progression rate of the ongoing digital conference call, the system predicts that the call will take longer (e.g., 7-10 minutes (min)) than the initially anticipated duration (e.g., 30 min). In one embodiment, the system learns that an ongoing discussion (i.e., within the context of the conference call) is confidential in nature, and learns that the content currently being shown on the display by one of the participants (e.g., by the financial controller) is also deemed to be confidential. According to at least one embodiment, the system detects the nature of a conference call using pre-trained speech recognition/conversation analytics models that monitor the content of the conference call. According to some embodiments, the system detects confidential content (e.g., the content being displayed) using a pre-trained content analytics model for digital content.

Referring to FIG. 3, a user interface 100 comprises one or more windows. A first window 101 shows content 102 (e.g., a document, spread sheet, etc.), a second window 103 shows a first live video stream 104 of an active participant and a second live video stream 105 of a second participant. According to at least one embodiment, the second live video stream 105 is selected automatically by the system. For example, based on an agenda for the meeting provided by a user (e.g., the host), the system selects a user whose title matches the next topic up for conversation according to the agenda. The user interface 100 further includes a third window 106 showing video streams for the remaining participants, including the host 107. It should be understood that the user interface can show other content to represent a user, for example, a stock image, an image provided by a given user, an emoji, etc.

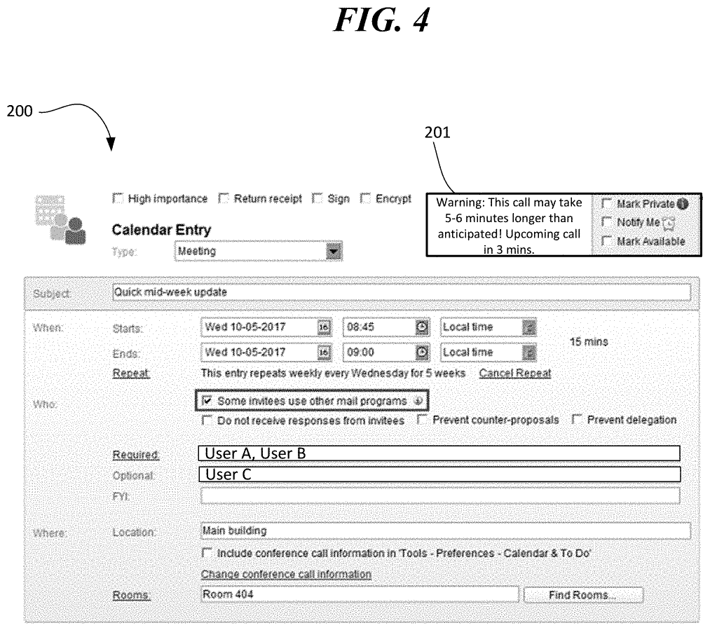

According to some embodiments and as shown in FIG. 4, the system includes a trained natural language model with access for a user's (e.g., host's) electronic calendar and configured to identify an upcoming call (e.g., within some set time threshold such as 3 minutes) with one or more different call participants (or groups) and to detect that one or more of the different call participants are calling to join the host conference room. According to some embodiments, the system outputs a warning 201, notifying the host that the current call and an upcoming call may overlap. In one embodiment, the system establishes the eligibility of call participants who are joining for the upcoming call to hear the ongoing discussion (i.e., the current call) and/or view the content displayed on the shared screen (i.e., of the current call). The system retrieves the profiles of each call participant in real-time (e.g., including the current participants and the different call participants) and checks the profiles with a detected confidentiality of the call content (e.g., of the discussion and the displayed content).

In one embodiment, an artificial intelligence (AI) agent is configured to assess the eligibility of attendee admittance to the conference room while they are in a virtual queueing or holding area.

According to an embodiment of the present invention and referring to FIG. 5, the system 300 configured to control conference call dial-in and holding queues includes modules 301-304. The system 300 is configured as a conference bridge connecting multiple participant calls simultaneously. According to some embodiments, the system 300 is configured to connect calls originating from one or more of traditional phone lines, private branch systems (PBX), Public Switched Telephone Networks (PSTN), Voice over IP (VoIP) calls, data network connections, etc. According to at least one embodiment, the system 300 is configured at a phone conference service provided to the participants. The modules 301-304 of the system 300 include a confidentiality classifier 301, a contextual profile identifier 302, a confidentiality restriction and control module 303, and a control action generator 304. The system 300 determines and predicts the confidentiality nature of the conversation and content using the confidentiality classifier 301. According to some embodiments, the prediction is made using a list of keywords sensitive to the discussion, group, project, etc. According to one or more embodiments, the confidentiality of the discussion or topic is inferred by the confidentiality classifier 301 from metadata associated with a scheduled call and from the data of the call (e.g., call marked confidential by a participant, analysis of content attached to a calendar event such as presentation slide decks marked confidential, a call agenda, etc.). According to at least one embodiment, for a call or meeting where the confidentiality is not marked, the confidentiality is learned or predicted from verbal queues, presented content containing confidentiality associated keywords (e.g., using real-time conversation analysis, topic analysis, content displayed and shared, etc.).

One or more machine learning models of the confidentiality classifier 301 can be trained on published confidential content (e.g., financial related document, strategy related document, HR-related documents, patent disclosures, white papers, blueprints, presentations, etc.) that has been released for viewing to the public but may be re-usable/publishable under licensed legal frameworks. This is indicative of confidential material that has matured and has since been legally released by the intellectual owner. According to one embodiment, the machine learning model identifies word embeddings in the content, and trains on the word embeddings to identify word relationships in confidential material, and subsequently uses the relationships to identify new material as confidential content.

According to some embodiments, the confidentiality classifier 301 performs in-call classification of data being exchanged by participant attendees. It should be understood that the term “data” comprises content shared by different participants of the call, data exchanged by the participants, voice data (or other audio), etc. Here, the confidentiality classifier 301 runs a machine learning model in an inference mode, which does not store any confidential information related to the call or meeting.

According to some embodiments and referring to FIG. 1, a user interface for a virtual holding queue 400 (identified as a VS or virtual space) includes a list of attendees 401 for a call and a discussion space 402 for these attendees in the virtual holding queue. Admittance of callers 401 to the meeting room (e.g., from the virtual holding queue 400) is controlled (i.e., limited) to trusted individuals. These trusted individuals may be dynamically identified by the system as described herein. Trusted individuals can be denoted in the list of attendees 401 by an icon 403 associated with the respective profiles.

According to at least one embodiment, the system determines and predicts confidentiality restrictions for each of the attendees to the call in the virtual holding queue 305 using the contextual profile analysis and classification module 301. According to some embodiments, the confidentiality classifier 301 uses a variety of data sources. For example, in at least one embodiment, the confidentiality classifier 301 uses an integrated calendar (see FIG. 4) is used to determine a list of invites/invitees (i.e., potential attendees). For example, the system retrieves data about the attendees from an email list entered in a calendar event.

According to at least one embodiment, the confidentiality classifier 301 and a contextual profile identification module 302 uses data from a system that manages an organizational/employee structure (e.g., in the form of a graph structure) to understand the contextual profiles. For example, a discussion may be extended to a call member's line manager (i.e., a newly added attendee) to facilitate business agreements and the contextual profile may be extended and transferred accordingly. According to some embodiments, the and contextual profile identification module 302 uses contextual indicators related to the contents of the call to profile individuals, e.g. trusted access on certain project calls. In one embodiment, the contextual profile identification module 302 uses an indication that an attendee in the virtual holding queue 305 is (e.g., determined or predicted to be) eligible to enter the call given the status of the data and the current content restrictions. According to some embodiments, the avatar (or other indicia) of such an eligible attendee in the virtual holding queue 305 can be highlighted to the host and/or computer system managing the call. For example, an eligible attendee can be automatically admitted to the call by the computer system based on the status of the data and the current content restrictions.

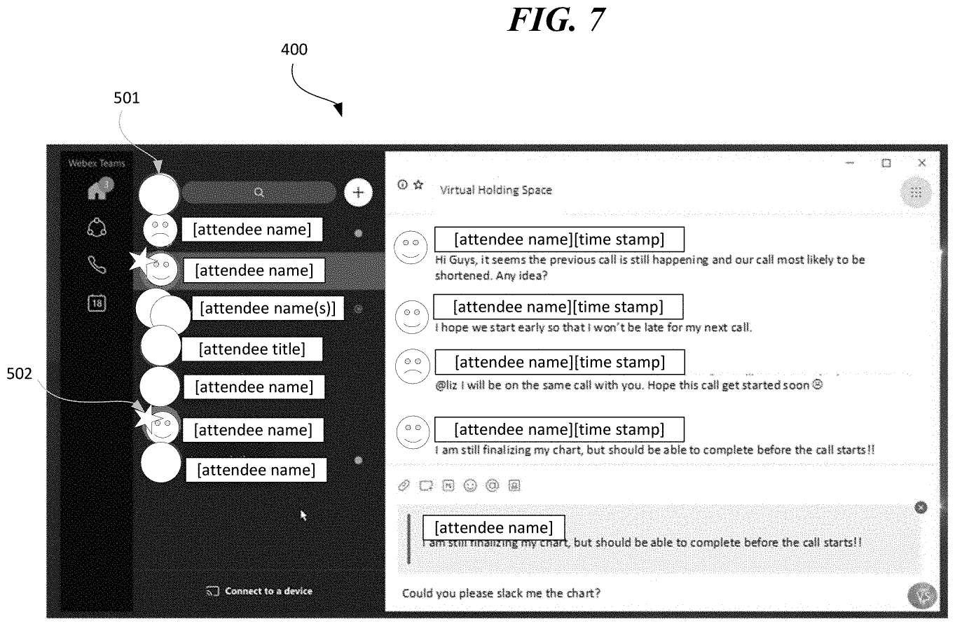

According to some embodiment and referring to FIG. 7, the user interface 400 includes an indication, e.g., a blank avatar 501 or a star 502, that the individuals in the virtual queue are (determined or predicted to be) ineligible/eligible to be admitted to the ongoing call. It should be understood that the indications can be variously embodied. For example, the indications are can be, for example, icons (e.g., circles, check marks), colors, etc. According to some embodiments, confidentiality restrictions can be highlighted and moved to a main call environment.

According to some embodiments, the virtual holding queue user interface 400 can be visible for host and trusted administrators. In one embodiment, the system's confidentiality restriction and control model 303 configured to control conference call features. According to some embodiments, the confidentiality restriction and control model 303 enforces confidentiality limitations to each profile in the conference call or virtual queue. According to one embodiment, the confidentiality restriction and control model 303 is a human-to-machine system, which includes a user interface. According to at least one embodiment, the confidentiality restriction and control model 303 enables conference call administrators to adjust confidentiality restrictions for attendees (e.g., individuals or parties) in the call or virtual queue. According to at least one embodiment, the confidentiality restriction and control model 303 categorizes, e.g., by tier or hierarchy, attendees to determine their restriction level.

According to at least one embodiment, based on the outputs of the confidentiality restriction and control module 303 and the contextual profile identification module 302, the control action generator module 304 places one or more restrictions on the conference call features for a subset of call members once it has generated a relevant controlling action(s). For example, according to at least one embodiment, the control action generator 304 is configured to disable audio, video or viewing functionalities to those restricted individuals until the ongoing conference call has completed. According to at least some embodiments, the control action generator 304 is configured to blur shared presentation content shown on the conference system, preventing new users joining the conference call who shouldn't have the privilege to see the displayed content, distort the speech or voice for those users who are joining the conference call where privilege to hear the discussion has not been granted, blur call member names, so that individuals or parties on the call are not visible to others who have (e.g., accidentally) dialed in, only making the host visible, preventing others from joining the audio or video conference system while alerting them to re-join after a specified time T, where Tis a predetermined time or a predicted time indicating when the call will last or the confidential or deemed to be confidential to the person joining the call, and/or keep others on-hold (in the virtual holding queue 305) for a specified time T and then automatically connecting them once the specified time T has elapsed (and the discussion and content displayed is deemed not confidential by the confidentiality classification module).

In an additional embodiment, where the restrictions and control module 303 has been manually tasked by the call host or administrators to restrict a given user profile to some subset of conference call features, the confidentiality restriction and control module 303 learns from the set of actions by retraining its machine learning component from the set of actions provided against the contextual profile identification module 302.

According to some embodiments, additional virtual holding queue 305 functionality is enforceable by the control action generator module 304. For example, while a person is on hold in the virtual queue, the meeting agenda is automatically displayed (e.g., from the host calendar invite, meeting agenda email notes, etc.). In another example, an interactive AI chatbot starts a dialog on behalf of the host, which could be routed to the host while the previous call is concluding. According to yet another example, simple chat functionality with the host is enabled while the caller is on hold, with no visibility in the call queue to the current call being held.

According to one or more embodiments, the virtual holding queue 305 includes a discussion board for those in the queue. According to some embodiments, the discussion board intelligently groups participant discussions/questions based on context and derived topics to ease individual's navigation and response.

According to some embodiments, a glare/reflectivity module 306 determines which pixels on the screen reflect off surfaces contained within the video call stream and remove and replace those pixels, e.g., through a pixel in-filling generator. An example of such a condition is an individual facing the camera that has glasses on or glass/mirrors contained in the video stream. These surfaces may reflect and present the presenter's screen to the audience members, subsequently revealing confidential information that only the presenter should appropriately view.

The methodologies of embodiments of the disclosure may be particularly well-suited for use in an electronic device or alternative system. Accordingly, embodiments of the present invention may take the form of an entirely hardware embodiment or an embodiment combining software and hardware aspects that may all generally be referred to herein as a “processor,” “circuit,” “module” or “system.”

Recapitulation:

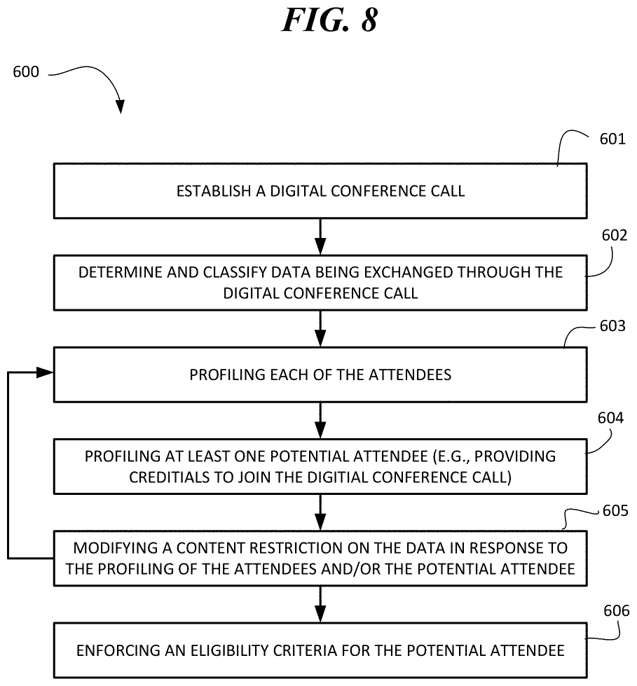

According to one or more embodiments of the present invention and referring to FIG. 8, a method 600 of operating a computer system configured to manage a digital conference call including a virtual holding queue includes establishing, by the computer system, the digital conference call connecting a plurality of current attendees 601, determining and classifying, by the computer system, in real-time a confidentiality status of data being exchanged by the plurality of current attendees through the digital conference call 602, profiling each of the current attendees 603, profiling at least one caller attempting to join the digital conference call 604, and modifying at least one content restriction on the data being exchanged in response to the profiling of the current attendees and the at least one caller 605. According to some embodiments, the computer system enforces an eligibility criterion for the at least one caller to join the digital conference call based on the confidentiality status of the data 606.

Furthermore, it should be noted that any of the methods described herein can include an additional step of providing a computer system implementing a method for anomaly alarm consolidation. Further, a computer program product can include a tangible computer-readable recordable storage medium with code adapted to be executed to carry out one or more method steps described herein, including the provision of the system with the distinct software modules.

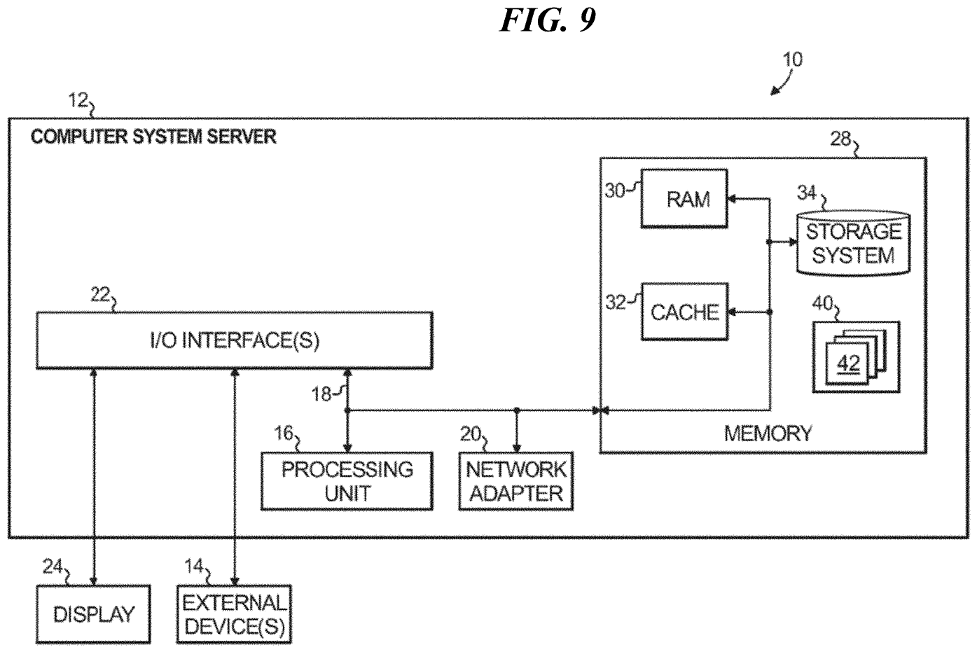

One or more embodiments of the invention, or elements thereof, can be implemented in the form of an apparatus including a memory and at least one processor that is coupled to the memory and operative to perform exemplary method steps. FIG. 9 depicts a computer system that may be useful in implementing one or more aspects and/or elements of the invention, also representative of a cloud computing node according to an embodiment of the present invention. Referring now to FIG. 9, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 9, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 9) running a server program. It will be understood that such a physical server may or may not include a display and keyboard.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of operating a computer system configured to manage a digital conference call including a virtual holding queue, the method comprising:
establishing, by the computer system, the digital conference call connecting a plurality of current attendees;
determining and classifying, by the computer system, in real-time a confidentiality status of data being exchanged by the plurality of current attendees through the digital conference call;
profiling each of the current attendees;
profiling at least one caller attempting to join the digital conference call;
modifying at least one content restriction on the data being exchanged in response to the profiling of the current attendees and the at least one caller; and
enforcing, by the computer system, an eligibility criteria for the at least one caller to join the digital conference call based on the confidentiality status of the data.

2. The method of claim 1, wherein the data comprises at least one of voice data of the current attendees, image data, and video data.

3. The method of claim 1, wherein the modifying includes at least one of a change in visibility of the data and a change in an available interaction available to the current attendees.

4. The method of claim 1, wherein the modifying includes dynamically restricting the at least one caller based on the eligibility criteria.

5. The method of claim 4, wherein the restriction of the at least one caller comprises at least one of disabling at least one of audio data, video data and viewing functionalities are until the digital conference call has completed, blurring of shared presentation content exchanged through the digital conference call, preventing the at least one caller from joining the conference call using a first privilege parameter related to the shared presentation content, distorting the data for the at least one caller who is joined to the digital conference call using a second privilege parameter related to audio content of the data, blurring, in a user interface of each of the current attendees, names of one or more of the current attendees, and preventing the at least one caller from joining the digital conference system while alerting the at least one caller to re-join after a specified time T, where T is a predicted duration of the digital conference call.

6. The method of claim 4, further comprising creating the virtual holding queue for holding the at least one caller attempting to join a next digital conference call, wherein the holding is established for a specified time T based on the established eligibility criteria.

7. The method of claim 1, wherein determining that the at least one caller in the virtual holding queue is eligible to confidentiality restrictions based on a contextual profile analysis of the at least one caller and a real-time analysis and classification of the data being exchanged.

8. The method of claim 1, further comprising automatically admitting the at least one caller to the digital conference call after a specified time T has elapsed and the data being exchanged is determined, by the computer system, to be not confidential to the at least one caller.

9. The method of claim 1, further comprising:
loading the at least one caller to a virtual holding queue prior to admittance to the digital conference call based on a contextual profile analysis of the at least one caller and a real-time analysis and classification of the data being exchanged; and
assessing an eligibility of the at least one caller for the digital conference call while the at least one caller is in the virtual holding queue.

10. The method of claim 1, further comprising displaying, automatically, an agenda in the virtual holding queue.

11. The method of claim 9, further comprising:
identifying, dynamically, at least one of the current attendees as a control agent for controlling admittance of the at least one caller to the digital conference call from the virtual holding queue;
enabling access of the control agent to one or more controls for controlling admittance to the digital conference call.

12. A non-transitory computer readable medium comprising computer executable instructions which when executed by a computer system cause the computer to perform the method of:
managing a digital conference call including a virtual holding queue, wherein the management further comprises:
determining and classifying, by the computer system, in real-time a confidentiality status of data being exchanged by a plurality of current attendees in the context of the digital conference call;
profiling each of the current attendees;
profiling at least one caller attempting to join the digital conference call;
modifying at least one content restriction on the data being exchanged in response to the profiling of the current attendees and the at least one caller; and
enforcing, by the computer system, an eligibility criteria for the at least one caller to join the digital conference call based on the confidentiality status of the data.

13. The non-transitory computer readable medium of claim 12, wherein the modifying includes at least one of a change in visibility of the data and a change in an available interaction available to the current attendees.

14. The non-transitory computer readable medium of claim 12, wherein the modifying includes dynamically restricting the at least one caller based on the eligibility criteria.

15. The non-transitory computer readable medium of claim 12, wherein the management further comprises creating a virtual holding queue for holding the at least one caller attempting to join a next digital conference call, wherein the holding is established for a specified time T based on the established eligibility criteria.

16. The non-transitory computer readable medium of claim 15, further comprising determining that the at least one caller in the virtual holding queue is eligible to confidentiality restrictions based on a contextual profile analysis of the at least one caller and a real-time analysis and classification of the data being exchanged.

17. The non-transitory computer readable medium of claim 12, wherein the management further comprises automatically admitting the at least one caller to the digital conference call after a specified time T has elapsed and the data being exchanged is determined, by the computer system, to be not confidential to the at least one caller.
